(19) United States
(12) Patent Application Publication
(10) Pub. No.: US 2023/0214628 A1
(43) Pub. Date: Jul. 6, 2023

(54) FOUR-CORNERED WIRELESS INFORMATION CARD

(71) Applicant: C2P Group Corp., Brooklyn, NY (US)

(72) Inventors: Yitzchok Furth, Brooklyn, NY (US); Shimon Smilowitz, Brooklyn, NY (US)

(21) Appl. No.: 18/088,772

(22) Filed: Dec. 27, 2022

Related U.S. Application Data
(60) Provisional application No. 63/295,461, filed on Dec. 30, 2021.

(51) Int. Cl. G06K 19/077

(52) U.S. Cl. CPC G06K 19/07766

(57) ABSTRACT

A four-cornered, wireless information conveying card comprises a card body defining at least four corners that are oriented in different directions with first, second, third and fourth information tags supported within said card body. Each information tag contains predetermined information therein, is located at a respective one of the at least four corners of the card body and has a respective antenna associated therewith. Each antenna is configured to communicate the predetermined information of its associated information tag wirelessly to a tag reader without interference from the other antennas.

### CROSS-REFERENCE TO RELATED APPLICATION

The present non-provisional patent application claims the benefit of and priority to U.S. Provisional Patent Application No. 63/295,461, filed Dec. 30, 2021, by Yitzchok Furth and Shimon Smilowitz, and entitled “FOUR-CORNERED WIRELESS INFORMATION CARD,” the entire contents of which are incorporated herein by reference.

### TECHNICAL FIELD

The present invention generally relates to near field communication tags, which may be provided as NFC active tags or RFID passive tags and, more particularly, to a credit card shaped and sized device that incorporates multiple NFC tags, enabling rapid and very convenient execution of different preset functions with the same device.

### BACKGROUND OF THE INVENTION

Near Field Communication (NFC) is a form of short range communication technology enabling devices in close proximity with each other to interact. At least one of the interacting devices needs to be an active device that initiates contact to the other device. The other device may be a passive device such as a passive Radio Frequency Identification (RFID) tag, which returns its content upon query by the active device. That is, in one operating mode, an active NFC device reads passive RFID or NFC tags. This allows various interactions between the users and their surroundings.

Typically, a single, either an RFID or NFC tags, is located in a small package and then used to active and open a front door lock or to identify a product or a file and the like. In the current art, people carry on their person multiple such tags, e.g., for their automobiles, front doors, and the like. It is difficult and avoided to include multiple tags package together owing to their interfering with each other in their wireless signal transmissions.

Prior art providing background information is available in the form of U.S. Pat. Nos. 8,432,262; 7,535,616; and 9,088,862, the contents of which are incorporated by reference herein.

### SUMMARY OF THE INVENTION

Aspects of the invention provide new and inventive solutions that can be used in connection with multiple tags packaged closely together, for example, on a credit card shaped and sized package.

According to a first example aspect of the invention there is provided a credit card shaped/sized package housing four NFC tags, with the antenna of each NFC tag housing at a respective corner region of the card, in a manner that avoids signal interference during wireless communications.

According to a further developed aspect of the present disclosure, a system is provided that enables use of the four-corner tag card to communicate with various financial, school or other institutions.

For example, in an embodiment, the invention comprises a four-cornered, wireless information conveying card having a card body defining at least four corners that are oriented in different directions with first, second, third and fourth information tags supported within said card body. Each information tag contains predetermined information therein, is associated with a respective one of the at least four corners of the card body and has a respective antenna located at the respective corner associated therewith. Each antenna is configured to communicate the predetermined information of its associated information tag wirelessly to a tag reader without interference from the other antennas.

In an embodiment, the location of each antenna inside the card body is visually marked on an exterior surface of the card, to assist users to more precisely position each corner of the card body relative to the tag reader. The card may include one or more of an internal smart chip controlling the tags, a Q-bar located on an exterior surface of the card body, a readable magnetic strip, date information and card identification information.

Other features and advantages of the present invention will become apparent from the following description of the invention which refers to the accompanying drawings.

### BRIEF DESCRIPTION OF THE DRAWINGS

The invention will be described, by way of example only, with reference to the accompanying drawings, in which:

FIG. 1 shows a credit card sized/shaped, multiple NFC tags device according to an example embodiment;

FIG. 2 shows the multiple NFC tags device of FIG. 1, perspectively.

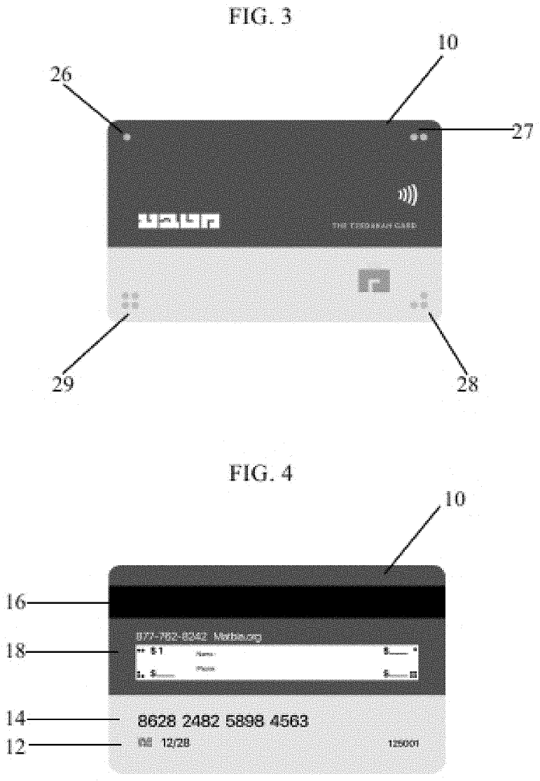

FIGS. 3 and 4 show the front and rear, respectively, of the multiple NFC tag card of the present invention that has been reduced to practice.

FIGS. 5 and 6 show an NFC reader device being used with the multi-tag, NFC card of the present invention.

FIG. 7 shows a block diagram of a system that utilizes the multi-tag, NFC card of the present invention.

FIGS. 8 and 9 are flow charts that depict system transactions involving various types of financial and like institutions that utilize the multi-tag, NFC card of the present invention.

### DETAILED DESCRIPTION OF PREFERRED EMBODIMENTS OF THE INVENTION

As noted at the outside, it is difficult to provide a multi-tag, NFC device where the tags are closely spaced because, as any given tag is placed in close proximity to the tag reader, the other tags might respond to interrogation signals and cause signal interference.

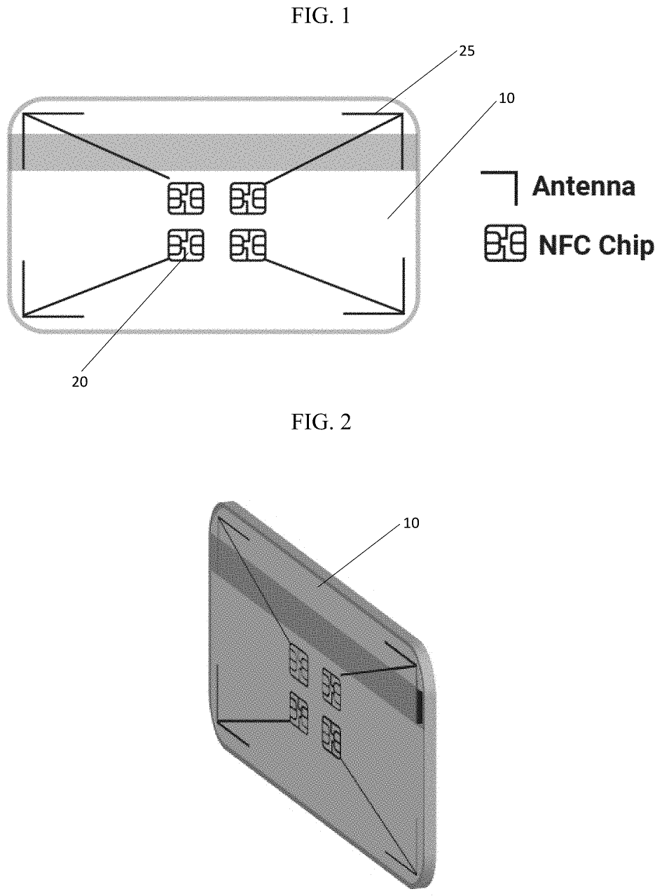

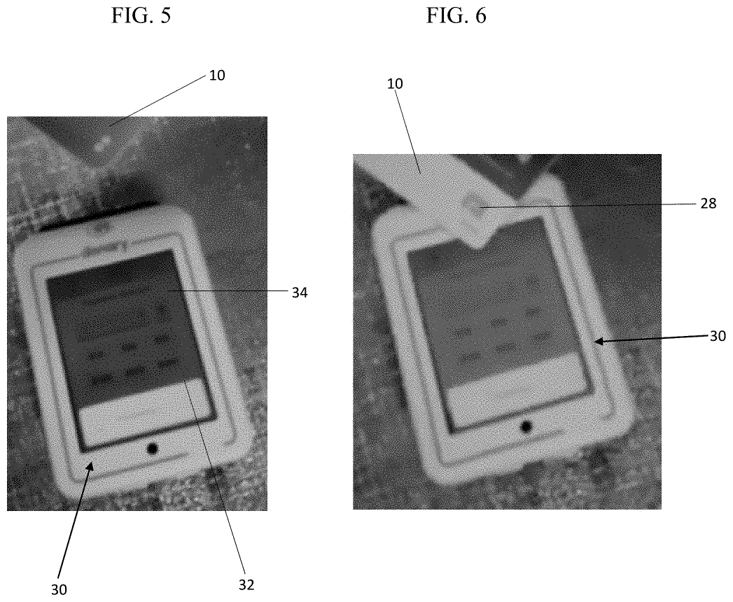

However, in accordance with the present invention and as shown in FIG. 1, the multi-tag NFC card 10 herein houses internally multiple tags 20, with each NFC tag 20 being coupled to a respective antenna 25 located at a respective corner of the rectangular package. As shown in FIG. 3, the location of each antennal 20 is indicated and identified by the dots 26, 27, 28 and 29, which as noted further on is consequential to the operation of the inventive card 10.

The multi-tag card 10 has been implemented as shown in FIGS. 3 and 4 in a rectangular card measuring about 80-90 mm in length, 30-40 mm in width and less than about 4 mm in thickness, preferably less than 3 mm or ,best, about 1 mm. The card 10 has front side with dots 26-29 indicating the locations of the internal antennas 25 with high directivity. The card 10 may include an internal smart chip found in conventional credit cards, a Q-bar, and on the rear side thereof a magnetic strip 16, and various date and similar indicia indicated by the reference numerals 12, 14 and 18.

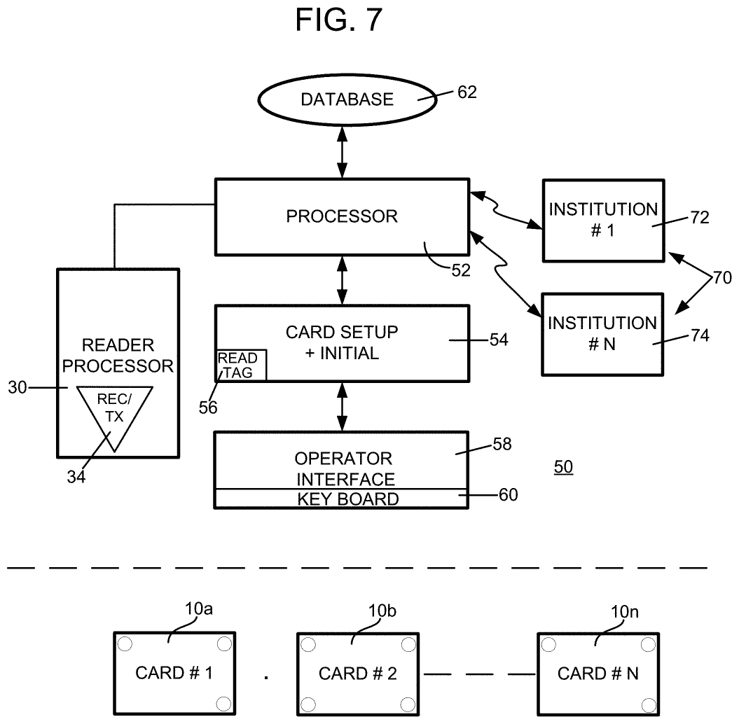

In conventional fashion, and as shown in FIGS. 5 and 6, each corner of the card 10 is designed to be selectively placed directly against or in close proximity of the reader spot 34 of the conventional tag reader 30 including a display 32 (with optional touch sensitive screen). In FIG. 6, the corner 28 of the multi-tag card 10 is placed against the reading spot 34 of the reader 30, which then causes the reader 30 to read the tag and carry out a pre-assigned/pre-programed functionality associated with this specific tag.

In accordance with one method of use contemplated by the inventors herein, the reader 30 communicates with a financial institution that recognizes that particular (unique) tag number and then proceed to debit the holder of the particular card to donate a fixed amount to a pre-defined charitable organization, for example $10. In similar manner, if the user of the card places another corner of the card 10 against the reader 30 the amount being contributed is $20, and so on for each corner, there being a unique amount that is being contributed to a charity organization.

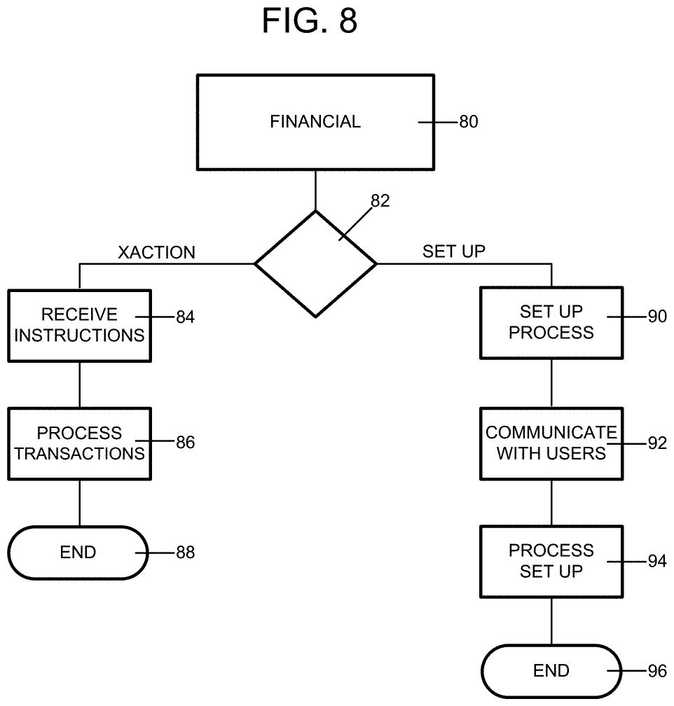

The system diagram of FIG. 7 elucidates the overall concept of the invention that is based on the four-corner, multi-tag card 10 of the present invention. Thus, the system 50 comprises a main processor/server 52 that communicates with the tag reader 30 having the reader signal receiver/interrogator 30. The reader 30, previously described, is configured to read anyone and each of the multi-tag NFC cards 10a, 10b 10n that have been issued to different users. The server 52 (whether physical or cloud-based) includes the firmware and software 54 to set up the cards 10 via operator interface 58 and keyboard 60. This information can be all stored in the database 62.

Thereby, in use of the system 50, the users may opt to present their individually-issued and unique cards to the reader 30, which conveys the tag information to the server 52 and then communicates that tag information to a third party institution such as the bank 72 or a school 74 and so on. The communication with the third party institutions may be for example via a fixed line communication module, e.g. an Ethernet or LAN communication module or even a radio communication module, e.g., a WLAN, GSM/GPRS, or WCDMA radio module.

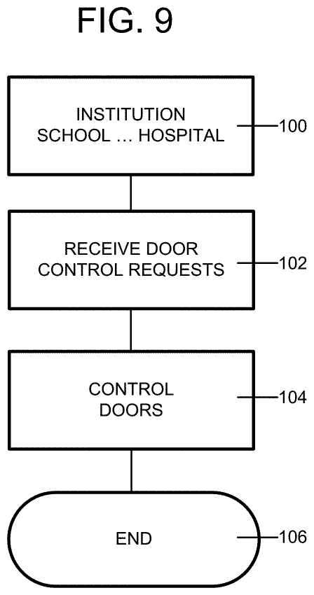

Referring now to FIGS. 8 and 9, these are purely exemplary flow charts showing that the server 52 may communicate with a financial institution 80 which operates software that queries whether the call concerns a transaction or a set up function. If a transaction, the receive instruction module 84 analyzes the type of transaction needed and then processes it at the module 86 sending a confirmation at module 88. If on the other hand the transaction requires setting up a new account or a new functionality, the set up module 90 analyzes the needed steps, communicates with users at the module 92 to secure approvals, and if approved, completes the set up function at 94 with confirmation being communicated at module 96.

In an embodiment, the card 10 was fabricated of PVC, the magstrip as an: HiCo Track 1 & Track 2, with the NFC being implemented with four F08-ISO14443A chips.

A virtual identical process is executed if the institution is a school or a hospital and the purpose of the cards 10 is to grant access to different spaces within these institution via the multi-tag NFC cards herein. For example, in a hypothetical school, the first corner of the card might allow access only to general lobby spaces, while another corner tag allows access through and operates (unlocks) doors associated with lunch area of the school or its gym facilities, while another corner allows access to individual class rooms, providing obviously improved school security and safety.

Various embodiments have been presented. It should be appreciated that in this document, words comprise, include and contain are each used as open-ended expressions with no intended exclusivity. The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention. It is also noted that the above embodiments are used merely to explain selected aspects or steps that may be utilized in implementations of the present invention. Some features may be presented only with reference to certain example embodiments of the invention. It should be appreciated that corresponding features may apply to other embodiments as well.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claim.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A four-cornered, wireless information conveying card, comprising:
a card body defining at least four corners that are oriented in different directions;
first, second, third and fourth information tags supported within said card body, each said information tag containing predetermined information therein, being associated with a respective one of said at least four corners of said card body and having a respective antenna associated therewith and located at respective corner; and
wherein each said antenna is configured to communicate the predetermined information of its associated information tag wirelessly to a tag reader without interference from the other antennas.

2. The wireless information conveying card of claim 1, wherein the tags are configured as NFC tags.

3. The wireless information conveying card of claim 1, wherein the tags are configured as RFID tags that are able to receive and store information within and to transmit stored information to said tag reader.

4. The wireless information conveying card of claim 1, wherein the card body is credit card shaped and sized.

5. The wireless information conveying card of claim 4, wherein the card body is dimensioned to be 80-90 mm in length, 30-40 mm in width and less than about 4 mm in thickness.

6. The wireless information conveying card of claim 1, wherein the location of each antenna inside the card body is visually marked on an exterior surface of the card, to assist users to more precisely position each corner of the card body relative to the tag reader.

7. The wireless information conveying card of claim 1, further including one or more of an internal smart chip controlling the tags, a Q-bar located on an exterior surface of the card body, a readable magnetic strip, date information and card identification information.

8. A transactions control system operable with wireless, information conveying cards, the transactions control system comprising:
a central server programmed with predetermined software modules to handle transaction requests from a plurality of users;
a plurality of said wireless information conveying cards, wherein each card has a card body defining at least four corners that are oriented in different directions; first, second, third and fourth information tags supported within said card body, each said information tag containing predetermined information therein, being associated with a respective one of said at least four corners of said card body and having a respective antenna associated therewith and located at said respective corner; and wherein each said antenna is configured to communicate the predetermined information of its associated tag wirelessly to a tag reader without interference from the other antennas, and wherein each said card is configured to transmit to said tag reader identity information that uniquely identifies a specific card from all the other cards; and
said tag readers being configured to communicate with said central server to cause said central server to deliver a preprogrammed functionality that is dependent on the identity of the card and on the corner of said card from which the information has been received.

9. The transaction control system of claim 8, wherein the central server is programmed to handle donations to charity requested to be made by the users based on which card corner has been presented to the tag reader.

10. The transaction control system of claim 1, wherein he central server is programmed to control access to various spaces within an institution by controlling the opening and closing of door locks associated with doors that provide controlled access to said spaces.

11. The transaction control system of claim 10, wherein said institution is a school and the users are students and personnel associated with said school.

12. The transaction control system of claim 8, including a management control facility associated with server that is configured to enable management personnel to control and monitor functions being carried out by said central server.

13. The transaction control system of claim 8, wherein the tags are configured as NFC tags.

14. The transaction control system of claim 8, wherein the tags are configured as RFID tags that are able to receive and store information within and to transmit stored information to said tag reader.

15. The transaction control system of claim 8, wherein the card body is dimensioned to be 80-90 mm in length, 30-40 mm in width and less than about 4 mm in thickness.

16. The transaction control system of claim 8, wherein the location of each antenna inside the card body is visually marked on an exterior surface of the card, to assist users to more precisely position each corner of the card body relative to the tag reader.

17. The transaction control system of claim 8, further including in each information conveying card: one or more of an internal smart chip controlling the tags, a Q-bar located on an exterior surface of the card body, a readable magnetic strip, date information and card identification information.
